(19) United States
(12) Patent Application Publication
(10) Pub. No.: US 2013/0297056 A1
(43) Pub. Date: Nov. 7, 2013

(54) PRODUCTION SYSTEM AND DATA GENERATION METHOD

(71) Applicant: JUKI CORPORATION, Tokyo (JP)

(72) Inventors: Tetsurou MIYAMOTO, Tokyo (JP); Tadamasa OKUDA, Tokyo (JP); Kouji SHIBATA, Tokyo (JP)

(73) Assignee: JUKI CORPORATION, Tokyo (JP)

(21) Appl. No.: 13/874,779

(22) Filed: May 1, 2013

(30) Foreign Application Priority Data
May 2, 2012 (JP) 2012-105358
Apr. 17, 2013 (JP) 2013-086316

(51) Int. Cl. G05B 15/02

(52) U.S. Cl. CPC G05B 15/02
USPC 700/96

(57) ABSTRACT

A production system which is centralizedly managed by a server so that electronic components fed from feeders are mounted on a board by each mounting apparatus, is configured so that the feeders are placed in predetermined placement regions of a feeder bank provided in the mounting apparatus, the server detects the placement regions where the feeders are placed, and manages the feeders and the placement regions in association with each other, and the mounting apparatus acquires management information from the server and automatically generates layout data indicating correspondence between the feeders and the placement regions.

### CROSS-REFERENCE TO RELATED APPLICATIONS

This application is based upon and claims the benefit of priority from Japanese Patent Application Nos. 2012-105358, filed on May 2, 2012, and 2013-086316, filed on Apr. 17, 2013; the entire contents of which are incorporated herein by reference.

### BACKGROUND OF INVENTION

1. Field of the Invention

The present invention relates to a production system in which a plurality of mounting apparatuses are managed by a server, and a data generation method which is used in the production system.

2. Related Art

Generally, in an electronic component mounting apparatus, a plurality of feeders (component feeding devices) are disposed side by side on a placement stage called feeder bank. Various kinds of electronic components are fed out sequentially toward a pickup position of a mount head from each feeder. When the mount head moves between each feeder and a substrate, electronic components are mounted on the substrate. A layout of the feeders on the feeder bank is defined based on layout data (suction data) generated in advance. The work of feeder placement is performed in accordance with the layout data by an operator before operation of the mounting apparatus.

As a technique for simplifying the work of feeder placement performed by an operator, there has been heretofore known a technique in which layout data are generated in accordance with placement positions of feeders (for example, see JP-A-2008-258658). In a mounting apparatus described in JP-A-2008-258658, a memory is provided in each feeder so that the position of placement of the feeder and the quantity of positional displacement during pickup are stored in the memory. In a control portion of the mounting apparatus, layout data are automatically generated based on the placement positions of the feeders read out from the memories of the feeders. In this manner, the work of feeder placement is not performed in accordance with the layout data but the layout data are generated automatically in accordance with the layout of the feeders.

### SUMMARY OF INVENTION

However, in the mounting apparatus described in JP-A-2008-258658, a memory for storing the position of placement must be provided for each feeder so that a device for reading/writing information from/into the memory is required. In addition, since various kinds of information for generating the layout data are stored only in the memory of each feeder, centralized management of data using a server is impossible so that the related art is not suitable for an environment provided with a plurality of mounting apparatuses, such as a factory.

The invention has been accomplished in consideration of such circumstances. An object of the invention is to provide a production system and a data generation method in which a preparation work prior to operation can be simplified and placement statuses of component feeding devices disposed in each mounting apparatus can be managed by a server.

A production system according to the invention is centralizedly managed by a server so that electronic components fed from component feeding devices are mounted on a substrate in a retention member of each mounting apparatus. The component feeding devices are disposed in predetermined placement regions of a placement section in which a plurality of placement regions are formed in the mounting apparatus. The server detects the placement regions where the component feeding devices are disposed, from the placement section, and manages the component feeding devices and the placement regions in association with each other. The mounting apparatus acquires management information from the server and automatically generates layout data indicating correspondence between the component feeding devices and the placement regions.

A data generation method according to the invention, used in a production system, is centralizedly managed by a server so that electronic components fed from component feeding devices are mounted on a substrate i n a retention member of each mounting apparatus. The method includes: a placement step of placing the component feeding devices in predetermined placement regions of a placement section in which a plurality of placement regions are formed in the mounting apparatus; a management step of allowing the server to detect the placement regions where the component feeding devices are disposed, from the placement section, and to manage the component feeding devices and the placement regions in association with each other; and a generation step of allowing the mounting apparatus to acquire management information from the server and to automatically generate layout data indicating correspondence between the component feeding devices and the placement regions.

According to these configurations, because the layout data indicating correspondence between the component feeding devices and the placement regions in the placement section are generated automatically, the work of generating layout data can be dispensed with to improve working efficiency. Moreover, it is unnecessary to dispose the component feeding devices in accordance with the layout data, so that working efficiency can be improved while operator's mistakes in working can be reduced. Moreover, since placement statuses of the component feeding devices are managed by the server, it is unnecessary to provide readable and writable memories in the component feeding devices respectively. In addition, since the server manages the component feeding devices while associating the component feeding devices with the placement regions, these configurations can be also applied an environment provided with a plurality of mounting apparatuses, such as a factory.

Moreover, in the production system according to the invention, the server manages intrinsic information of the component feeding devices in association with identification information of the component feeding devices, and the mounting apparatus automatically generates the layout data including the intrinsic information of the component feeding devices.

In the data generation method according to the invention: in the management step, the server manages intrinsic information of the component feeding devices in association with identification information of the component feeding devices; and in the generation step, the mounting apparatus automatically generates the layout data including the intrinsic information of the component feeding devices.

According to these configurations, because the identification information is associated with the intrinsic information of the component feeding devices, the intrinsic information of the component feeding devices can be taken over to destination placement regions even when the layout of the component feeding devices is changed. Thus, because it is unnecessary to reset the intrinsic information of the component feeding devices after the change of the layout, working efficiency can be improved.

In addition, in the production system according to the invention, the server manages, as the intrinsic information of the component feeding devices, correction quantities for retention positions of the electronic components when the electronic components are delivered to the mounting apparatus from the component feeding devices, in association with the identification information of the component feeding devices, and the mounting apparatus corrects the retention positions of the electronic components initially set based on the placement regions by the correction quantities and automatically generates the layout data including the retention positions of the electronic components.

In the data generation method according to the invention: in the management step, the server manages, as the intrinsic information of the component feeding devices, correction quantities for retention positions of the electronic components when the electronic components are delivered to the mounting apparatus from the component feeding devices, in association with the identification information of the component feeding devices; and in the generation step, the mounting apparatus corrects the retention positions of the electronic components initially set based on the placement regions by the correction quantities, and automatically generates the layout data including the retention positions of the electronic components.

According to these configurations, because the correction quantities are associated with the identification information of the component feeding devices, the correction quantities can be taken over to the destination placement regions even when the layout of the component feeding devices is changed. Thus, because it is unnecessary to correct positional displacements of the retention positions of the electronic components again after the change of the layout, working efficiency can be improved.

In addition, in the production system according to the invention, the server manages, as the intrinsic information of the component feeding devices, information indicating use or non-use of the component feeding devices in association with the identification information of the component feeding devices, and the mounting apparatus automatically generates the layout data including the information indicating use or non-use.

In the data generation method according to the invention: in the management step, the server manages, as the intrinsic information of the component feeding devices, information indicating use or non-use of the component feeding devices in association with the identification information of the component feeding devices; and in the generation step, the mounting apparatus automatically generates the layout data including the information indicating use or non-use.

According to these configurations, because the information indicating use or non-use is associated with the identification information of the component feeding devices, the information indicating use or non-use can be taken over to the destination placement regions even when the layout of the component feeding devices is changed. Thus, because it is unnecessary to reset use or non-use of the component feeding devices after the change of the layout, working efficiency can be improved.

In addition, in the production system according to the invention, the server detects the placement regions of the component feeding devices by proximity communication between the placement sections and the component feeding devices. In the data generation method according to the invention: in the management step, the server detects the placement regions of the component feeding devices by proximity communication between the placement section and the component feeding devices. According to these configurations, regions where the component feeding devices are placed can be detected in a simple configuration.

In addition, in the production system according to the invention, a plurality of production programs for mounting the electronic components on the substrate from the component feeding devices are stored in the mounting apparatus, layout configurations of the component feeding devices used in the production programs respectively are set in the plurality of production programs, and the mounting apparatus acquires the management information from the server and informs of similarities between a current layout configuration of the component feeding devices contained in the management information and the layout configurations of the component feeding devices in the plurality of production programs.

The data generation method according to the invention further includes an informing step of allowing the mounting apparatus to acquire the management information from the server and to inform of similarities between a current layout configuration of the component feeding devices included in the management information and layout configurations of the component feeding devices in a plurality of production programs when the plurality of production programs for mounting the electronic components on the substrate from the component feeding devices are stored in the mounting apparatus and the layout configurations of the component feeding devices used in the production programs respectively are set in the plurality of production programs.

According to these configurations, similarities between the current layout configuration of the component feeding devices and the layout configurations of the component feeding devices used in the plurality of production programs can be recognized by an operator. Thus, the operator can select a production program most similar to the current layout configuration of the component feeding devices so that a preparation work prior to operation, such as rearrangement of the component feeding devices, can be simplified.

According to the invention, because layout data can be generated automatically in accordance with the placement of the component feeding devices, the preparation work prior to operation can be simplified and the placement statuses of the component feeding devices placed in the mounting apparatus can be managed by the server.

### BRIEF DESCRIPTION OF THE DRAWINGS

FIG. 1 is a schematic view of a production system according to an embodiment of the invention;

FIG. 2 is a perspective view of a mounting apparatus according to the embodiment;

FIGS. 3A and 3B are views showing an example of layout change of feeders according to the embodiment;

FIG. 4 is a view showing an example of a teaching process according to the embodiment;

FIG. 5 is a flow chart showing an example of a layout data automatic generation process in the embodiment;

FIG. 6 is a view showing a current feeder layout according to the embodiment;

FIG. 7 is a view showing an example of display of production programs according to the embodiment; and

FIG. 8 is a view showing an example of a production program display process according to the embodiment.

### DETAILED DESCRIPTION

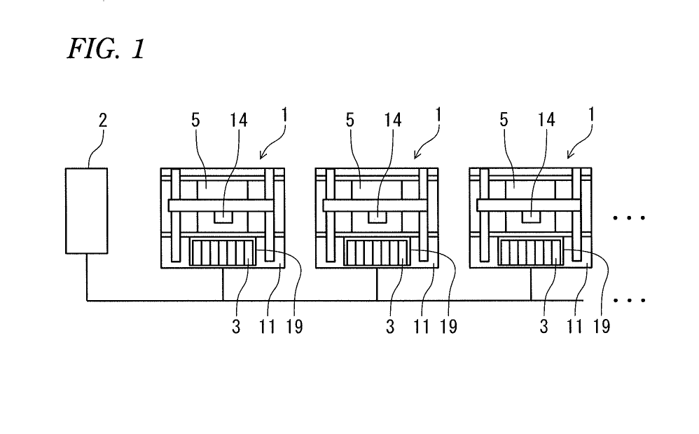

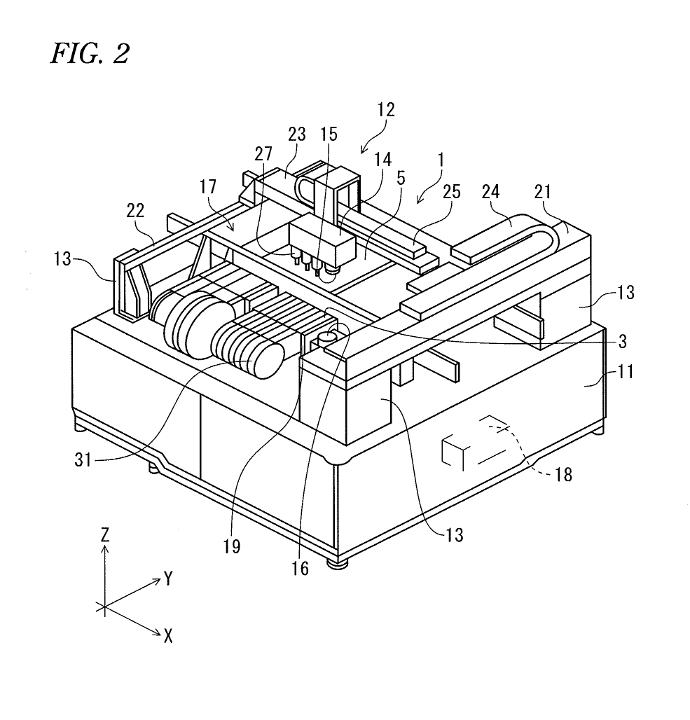

An embodiment of the invention will be described below in detail with reference to the accompanying drawings. FIG. 1 is a schematic view of a production system according to this embodiment. FIG. 2 is a perspective view of a mounting apparatus according to this embodiment. Although a modular type mounting apparatus will be described below by way of example, the invention is not limited thereto but may be changed properly. For example, the invention can be also applied to a rotary type mounting apparatus.

As shown in FIG. 1, the production system according to this embodiment has a plurality of mounting apparatuses 1, and a server 2. The production system is configured so that the mounting apparatuses 1 are connected to the server 2 by wire connection of LAN cables etc., respectively. The server 2 acquires various kinds of information from the mounting apparatuses 1 to thereby perform centralized management of the mounting apparatuses 1. In addition, a plurality of feeders (component feeding devices) 3 are disposed in a feeder bank (placement section) 19 of each mounting apparatus 1. When a feeder 3 is disposed in the feeder bank 19, the position where the feeder 3 is disposed is real-time transmitted to the server 2 so that the server 2 manages the placement of the feeder.

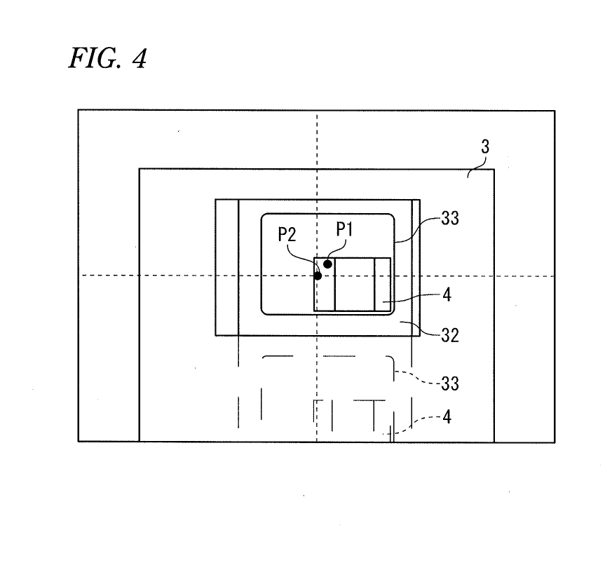

As shown in FIGS. 1 and 2, each mounting apparatus 1 is configured so that electronic components 4 (see FIG. 4) fed from the feeders 3 are mounted on a board 5 (substrate) on a base 11 by a mount head 14. A mount head moving mechanism 12 for moving the mount head 14 in an X-axis direction and a Y-axis direction is provided on the base 11. The mount head moving mechanism 12 is supported by strut portions 13 which are provided in four corners of the base 11 so as to be erected. The mount head moving mechanism 12 moves the mount head 14 in the X-axis direction and the Y-axis direction at a predetermined height from a top surface of the base 11.

The mount head moving mechanism 12 has a Y-axis table 21 and a slide guide 22 which are supported on the strut portions 13 so as to be parallel to the Y-axis direction, and an X-axis table 23 which is supported on the Y-axis table 21 and the slide guide 22 so as to be parallel to the X-axis direction. The mount head 14 is supported by the X-axis table 23 so as to be movable in the X-axis direction. Cableveyors (registered trademark) 24 and 25 containing various kinds of cables such as power cables are provided on the Y-axis table 21 and on the X-axis table 23, respectively.

The mount head moving mechanism 12 moves the mount head 14 in the X-axis direction along the X-axis table 23 by using a motor not shown. In addition, the mount head moving mechanism 12 further moves the mount head 14, together with the X-axis table 23, in the Y-axis direction along the Y-axis table 21 and the slide guide 22 by using a motor not shown. In such a configuration, the mount head 14 can be moved horizontally above the board 5 to carry an electronic component 4 fed from each feeder 3 to a desired position of the board 5.

The mount head 14 has a plurality of suction nozzles 27 (retention members) which can suck the electronic components 4. Each suction nozzle 27 is rotated on a Z axis by a 0 motor not shown, and is moved vertically in the Z-axis direction by a Z-axis motor not shown. The mount head 14 is configured so that the suction nozzles 27 can be driven individually to suck a plurality of electronic components 4 from the feeders 3. Any nozzles may be used as the nozzles (retention members) of the mount head 14 as long as the nozzles can take electronic components 4 out of the feeders 3. For example, the nozzles may be formed as gripper nozzles.

An imaging portion 15 for teaching and a height sensor not shown are provided near the suction nozzles 27. The imaging portion 15 takes an image of a mark of an electronic component 4 fed out to a delivery position of each feeder 3 or an image of a mark of the board 5. The suction position (retention position) of the electronic component 4 or the mount position of the board 5 in the X-axis direction and the Y-axis direction is adjusted based on the image taken by the imaging portion 15. The height sensor measures the height by emitting light toward the electronic component 4 or the board 5 and receiving reflected light. The suction position of the electronic component 4 or the mount position of the board 5 in the Z-axis direction is adjusted based on the measurement result of the height sensor.

An imaging portion 16 for performing accurate component recognition is provided on the base 11. An image of an electronic component 4 sucked by each suction nozzle 27 is taken from below by the imaging portion 16. The quantity of positional displacement between the suction center and the component center and the inclination of the electronic component 4 are obtained based on the image taken by the imaging portion 16. In addition, a board conveyance portion 17 for positioning the board 5 to a place below the mount head 14 is provided on the base 11. The board conveyance portion 17 imports the board 5 before component mounting from one end side and conveys the board 5 out after component mounting from the other end side by using a conveyance belt or the like extending in the X-axis direction.

The respective portions of the mounting apparatus 1 are generally controlled by a control portion 18. The control portion 18 includes a processor for executing various kinds of processes of the mounting apparatus 1, a memory, etc. The memory is made of one storage medium or a plurality of storage media such as ROM (Read Only Memory) or RAM (Random Access Memory) in accordance with use purposes. The control portion 18 of the mounting apparatus 1 is connected to the server 2 by a LAN cable or the like. The control portion 18 transmits a correction quantity of the suction position obtained by teaching to the server 2. Incidentally, the aforementioned mount head 14 may have a detection portion which detects a bad mark or the like given to a broken board, etc.

Electronic components 4 are fed to the mount apparatus 1 from the feeders 3 disposed along the board conveyance portion 17. The feeders 3 are disposed side by side in the box-like feeder bank 19 which has top and rear surfaces opened. A tape reel 31 is detachably attached to each feeder 3. A tape on which a large number of electronic components 4 are retained is wound on the tape reel 31. Each feeder 3 pays out the electronic components 4 sequentially toward the delivery position by rotation of the tape reel 31 so that each of the electronic components 4 can be picked up at the delivery position by the mount head 14.

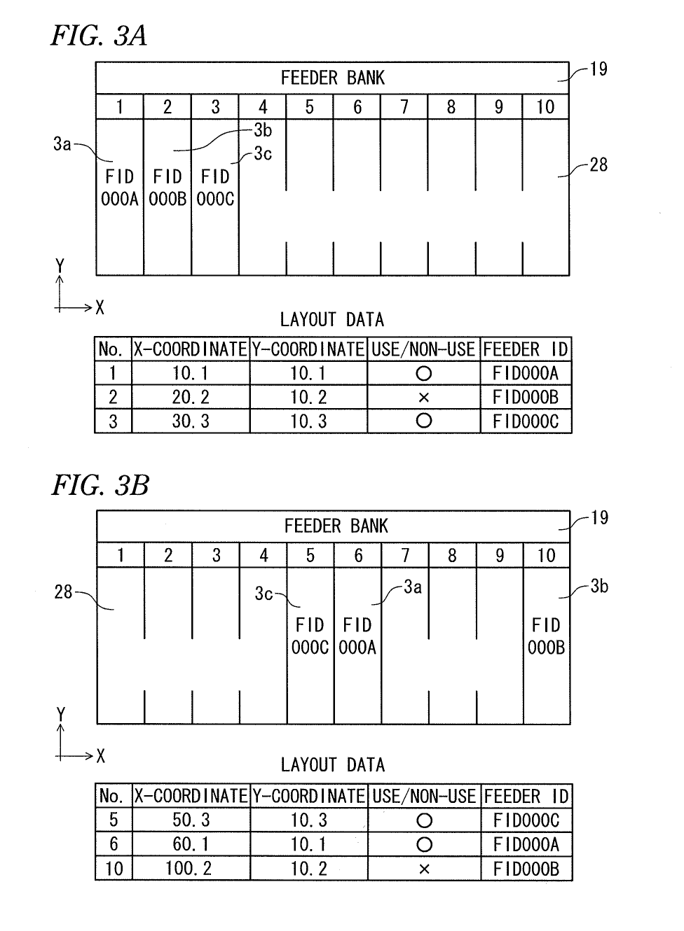

An RFID tag (proximity communication) not shown is mounted on each feeder 3. A feeder ID is stored in the RFID tag. The feeder bank 19 has placement regions 28 (see FIG. 3) in each of which a feeder 3 can be disposed. A plurality of not-shown RFID antennas capable of communicating with the RFID tags of the feeders 3 are disposed in the placement regions 28. The feeder bank 19 is connected to the server 2 by another wiring than the wiring by which the control portion 18 of the mounting apparatus 1 is connected to the server 2. When a feeder 3 is placed in one of the placement regions 28 of the feeder bank 19, the RFID tag and the RFID antenna come close to each other so that the feeder ID stored in the RFID tag is real-time transmitted from the feeder bank 19 to the server 2.

The server 2 manages the placement regions 28 of the feeder bank 19 in association with the feeder IDs received from the feeder bank 19. In addition, the server 2 further manages intrinsic information of the feeders 3, such as correction quantities of suction positions and use/not-use of the feeders 3, received from the control portion 18 of the mounting apparatus 1, in association with the feeder IDs. Therefore, even when the layout of the feeders 3 is changed, the intrinsic information of the feeders 3 can be taken over to the designation placement regions 28. The management information is transmitted to the control portion 18 of the mounting apparatus 1 so as to be used for a process of automatically generating layout data (suction data) indicating correspondence between the feeders 3 and the placement regions 28.

Incidentally, although the configuration in which a feeder ID is stored in each RFID tag has been described in the embodiment, the invention is not limited to this configuration. Identification information by which the feeder 3 can be identified may be stored in the RFID tag. In addition, although the configuration in which the feeder ID is read out from the feeder 3 by the RFID tag and transmitted to the server 2 has been described in the embodiment, the invention is not limited to this configuration. For example, configuration may be made so that a barcode (proximity communication) attached to each feeder 3 and each placement region 28 of the feeder bank 19 is read out and transmitted to the server 2.

Layout change of feeders will be described with reference to FIGS. 3A and 3B. FIGS. 3A and 3B are views showing an example of layout change of feeders according to the embodiment. FIG. 3A shows a state before the layout change. FIG. 3B shows a state after the layout change. FIG. 4 is a view showing an example of a teaching process according to the embodiment.

As shown in FIGS. 3A and 3B, region numbers 1 to 10 are set for placement regions 28 of a feeder bank 19 (placement section), respectively. In the state before the layout change shown in FIG. 3A, feeders 3a to 3c are placed in the placement regions 28 designated by the region numbers 1 to 3. When the feeders 3a to 3c are placed in the feeder bank 19, feeder IDs (000A, 000B and 000C) are transmitted from the feeder bank 19 to the server 2. The server 2 manages the feeder IDs in association with the region numbers 1 to 3 of the feeder bank 19. On this occasion, (10.0, 10.0), (20.0, 10.0) and (30.0, 10.0) are set as initial setting for suction positions (X-, Y-coordinates) of electronic components 4 delivered to the mounting apparatus 1 from the feeders 3a to 3c placed in the region numbers 1 to 3.

In each of the feeders 3a to 3c, an electronic component 4 is paid out to a delivery position with a slight gap so that a positional displacement occurs in the suction position of the electronic component 4. Since the displacement is intrinsic to the feeder, a teaching process is performed in accordance with each of the feeders 3a to 3c. As shown in FIG. 4, the teaching process is performed by imaging the vicinity of the delivery position of the feeder 3. In the feeder 3, a surface cover tape is removed from a carrier tape 32 in which electronic components 4 are packaged, so that an electronic component 4 in a pocket 33 of the carrier tape 32 is fed out toward the delivery position. In the teaching process, a correction quantity is calculated based on a difference between a center position P1 of the pocket 33 and a predetermined suction position P2 with reference to the outer frame of the pocket 33 in the taken image.

The correction quantity of the suction position of each of the feeders 3a to 3c is stored in the control portion 18 of the mounting apparatus 1 and transmitted to the server 2. In the embodiment, (+0.1, +0.1), (+0.2, +0.2) and (+0.3, +0.3) are calculated as the correction quantities of the feeders 3a to 3c, respectively. The server 2 manages the correction quantities of the feeders 3a to 3c in association with the feeder IDs of the feeders 3a to 3c. In addition, a use status indicating use or non-use can be set for each feeder 3.

For example, the feeder 3b is set as non-use. The server 2 further manages information indicating use or non-use in association with the feeder IDs of the feeders 3a to 3c.

The management information of the server 2 is transmitted to the control portion 18 of the mounting apparatus 1. The control portion 18 automatically generates layout data in association with the region numbers of the feeder bank 19, the suction positions of the electronic components 4, the use statuses of the feeders 3 and the feeder IDs. On this occasion, (10.1, 10.1), (20.2, 10.2) and (30.3, 10.3) obtained by correcting the suction positions of the initial setting by the correction quantities of the teaching contained in the management information are set as the suction positions of the electronic components 4 of the feeders 3a to 3c, respectively. In this manner, the mounting apparatus 1 fetches the management information from the server 2 and generates the layout data automatically.

In the state after the layout change shown in FIG. 3B, the feeder 3c is placed in the region number 5, the feeder 3a is placed in the region number 6 and the non-use feeder 3b is placed in the region number 10. When the layout of the feeders 3a to 3c in the feeder bank 19 is changed, the feeder IDs are transmitted from the feeder bank 19 to the server 2. The server 2 manages the feeder IDs in association with the region numbers 5, 6 and 10 of the feeder bank 19. On this occasion, (50.0, 10.0), (60.0, 10.0) and (100.0, 10.0) are set as initial positions for the suction positions (X- and Y-coordinates) of the electronic components 4 in the region numbers 5, 6 and 10.

On this occasion, the server 2 manages the correction quantities of the electronic components 4 and the use statuses in association with the feeder IDs. Therefore, even when the layout of the feeders 3a to 3c in the feeder bank 19 is changed, the correction quantities of the electronic components 4 and the use statuses are taken over. The management information of the server 2 is transmitted to the control portion 18 of the mounting apparatus 1. The control portion 18 updates the layout data in association with the region numbers of the feeder bank 19, the suction positions of the electronic components 4, the use statuses of the feeders 3 and the feeder IDs. On this occasion, (50.3, 10.3), (60.1, 10.1) and (100.2, 10.2) obtained by correcting the suction positions of the initial setting by the correction quantities of the teaching contained in the management information are set as the suction positions of the electronic components 4 of the feeders 3a to 3c, respectively.

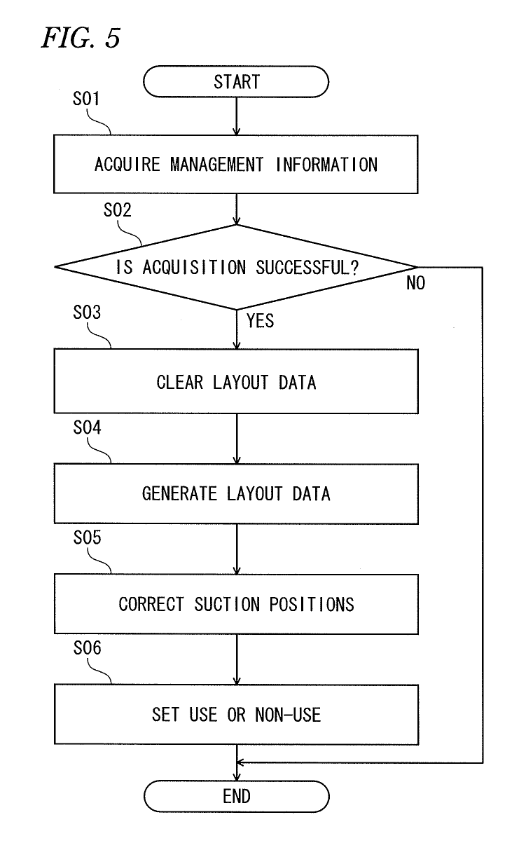

A layout data automatic generation process performed by the mounting apparatus 1 will be described with reference to FIG. 5. FIG. 5 is a flow chart showing an example of the layout data automatic generation process in the embodiment. In FIG. 5, assume that feeders 3 are placed in the feeder bank 19, and that the server 2 manages the feeder IDs and the region numbers of the feeder bank in association with each other.

As shown in FIG. 5, the control portion 18 of the mounting apparatus 1 acquires management information indicating the layout of the feeders from the server 2 (step S01). When the control portion 18 has failed in acquiring the management information (No in step S02), the control portion 18 then terminates the layout data automatic generation process. On the other hand, when the control portion 18 has succeeded in acquiring the management information (Yes in step S02), the control portion 18 clears the previous layout date stored in the memory (step S03). Then, the control portion 18 automatically generates layout data based on the region numbers of the feeder bank 19 and the feeder IDs contained in the management information (step S04).

The layout data are generated in association with the region numbers of the feeder bank 19, the suction positions of electronic components 4, the use statuses of the feeders 3 and the feeder IDs. At this point of time, suction positions of initial setting corresponding to the placement regions 28 of the feeder bank 19 are set as the suction positions of the electronic components 4. Neither use nor non-use is set as initial setting for the use status of each feeder 3. Incidentally, use or non-use may be set as initial setting for the use status of each feeder 3.

Then, the control portion 18 acquires correction quantities of the feeders 3 obtained by teaching and contained in the management information from the server 2, and corrects the suction positions of the electronic components 4 (step S05). The correction quantities of the feeders 3 are associated with the feeder IDs and used for correction of the suction positions of the electronic components 4 corresponding to the feeder IDs respectively. Then, the control portion 18 acquires the use statuses of the feeders 3 contained in the management information from the server 2, and sets use or non-use for the feeders 3 (step S06). The us e statuses of the feeders 3 are associated with the feeder IDs. Use or non-use is set in accordance with each feeder ID.

In this manner, in the layout data automatic generation process, previous data are cleared and new data are automatically generated based on the management information given from the server 2. On this occasion, intrinsic information of the feeders 3 such as the correction quantities and the use statuses of the feeders 3 is associated with the feeder IDs. Therefore, layout data are generated in the condition that the intrinsic information of the feeders 3 is taken over to the designations regardless of change of the layout of the feeders 3.

As described above, in accordance with the production system according to the embodiment, layout data indicating correspondence between the feeders 3 and the placement regions 28 of the feeder bank 19 are automatically generated. Accordingly, the work of generating layout data can be dispensed with to improve working efficiency. Moreover, because it is unnecessary to place the feeders 3 in accordance with the layout data, working efficiency can be improved while operator's mistakes in working can be reduced. Moreover, since the server 2 manages the placement statuses of the feeders 3, it is unnecessary to provide any readable and writable memory in each feeder 3. Further, since the server 2 manages various kinds of information, the production system according to the embodiment can be also applied to an environment provided with a plurality of mounting apparatuses 1, such as a factory.

Incidentally, a plurality of production programs for mounting electronic components 4 on a board 5 from the feeders 3 are stored in the control portion 18 of the mounting apparatus 1. Each of the production programs is set so that the mount head 14 is moved between each feeder 3 and the mount position on the board 5 in accordance with a layout configuration indicating the placement of the feeder relative to the feeder bank 19 and mount data indicating the mount positions of the electronic components 4 on the board 5. Generally, there is a prior work (setup work) which requires an operator to place the feeders 3 in the feeder bank 19 in accordance with the layout configuration of the feeders 3 contained in the production program before operation of the mounting apparatus 1. There is a possibility that operation of the mounting apparatus 1 will be delayed as the load imposed on the operator's work increases.

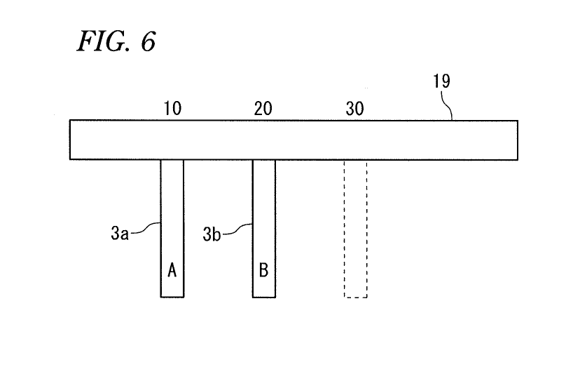

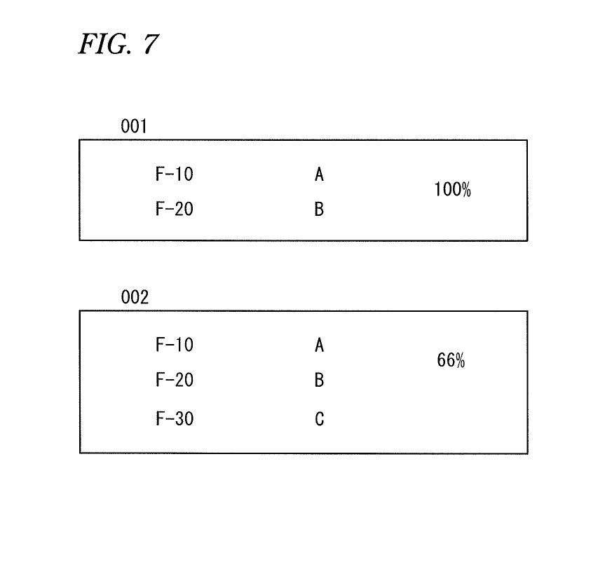

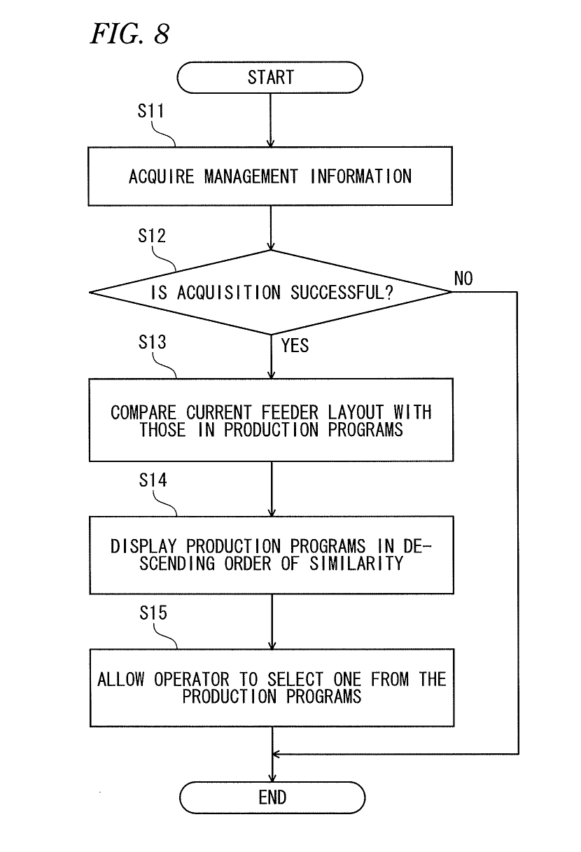

Therefore, according to the embodiment, a production program close to the current feeder layout is selected by the operator to thereby attain simplification of the preparation work prior to operation. A production program selection method will be described below with reference to FIGS. 6 to 8. FIG. 6 is a view showing the current feeder layout according to the embodiment. FIG. 7 is a view showing an example of display of production programs according to the embodiment. FIG. 8 is a flow chart showing an example of a production program display process according to the embodiment.

In the current feeder layout shown in FIG. 6, a feeder 3a is placed in a region number 10 and a feeder 3b is placed in a region number 20, among three placement regions designated by region numbers 10, 20 and 30 in the feeder bank 19. There is no feeder 3 placed in the region number 30. Therefore, the server 2 manages the region numbers 10 and 20 and the feeders 3a and 3b in association with each other. Here, kinds A and B of electronic components 4 fed by the feeders 3a and 3b are managed in association with the region numbers 10 and 20 respectively.

On the other hand, the mounting apparatus 1 acquires management information from the server 2 and recognizes the current feeder layout based on the management information. The mounting apparatus 1 recognizes, from the management information, the fact that the feeder 3a is associated with the region number 10 of the feeder bank 19 and the feeder 3b is associated with the region number 20 of the feeder bank 19. The mounting apparatus 1 further recognizes the fact that the kinds A and B of the electronic components 4 fed by the feeders 3a and 3b are associated with the region numbers 10 and 20 of the feeder bank 19, respectively.

Moreover, as shown in FIG. 7, a plurality of production programs are stored in the mounting apparatus 1 and the plurality of production programs are displayed on the display. In this case, layout configurations of the feeders 3 used in these production programs are displayed as the production programs. For example, a layout configuration in which kinds A and B of electronic components 4 are associated with the region numbers 10 and 20 of the feeder bank 19 respectively is displayed as a production program 001. Moreover, a layout configuration in which kinds A, B and C of electronic components 4 are associated with the region numbers 10, 20 and 30 of the feeder bank 19 respectively is displayed as a production program 002.

Similarity between the layout configuration of the feeders 3 indicated in the management information and the layout configuration of the feeders 3 indicated by each of the production programs is displayed in a place next to the layout configuration of the feeders 3 of the production program. Accordingly, the feeder layout used in each of the production programs can be compared with the current feeder layout. For example, in the layout configuration of the feeders 3 in the production program 001, the kinds A and B of the electronic components 4 are associated with the region numbers 10 and 20 of the feeder bank 19, so that the feeder layout in the production program 001 is the same as the current feeder layout. Therefore, similarity to the current feeder layout is displayed as 100% in a place next to the layout configuration of the feeders 3 of the production program 001.

On the other hand, in the layout configuration of the feeders 3 of the production program 002, the kinds A, B and C of the electronic components 4 are associated with the region numbers 10, 20 and 30 of the feeder bank 19 respectively, so that the feeder layout is different from the current feeder layout only in the region number 30. Accordingly, similarity to the current feeder layout is displayed as 66% in a place next to the layout configuration of the feeders 3 of the production program 002. Thus, the production programs are displayed in descending order of similarity on the display of the mounting apparatus 1 so that the operator can recognize a production program with higher similarity. In this manner, the operator can select a production program closest to the current feeder layout to increase efficiency of the preparation work prior to operation, such as rearrangement of the feeders 3.

Although this embodiment ha s shown the configuration in which similarity is calculated based on whether or not the current feeder layout coincides with each of the production programs in terms of the region numbers of the feeder bank 19 and the kinds of the electronic components 4, the similarity calculation method is not particularly limited.

When, for example, the current feeder layout coincides with the production program in the kinds of electronic components except the region numbers, similarity of the production program to the current feeder layout may be calculated to be high.

A production program display process according to the embodiment will be described with reference to FIG. 8. As shown in FIG. 8, the control portion 18 of the mounting apparatus 1 acquires management information indicating the current feeder layout from the server 2 (step S11). Then, when the control portion 18 has failed in acquiring the management information (No in step S12), the control portion 18 terminates the production program display process. On the other hand, when the control portion 18 has succeeded in acquiring the management information (Yes in step S12), the control portion 18 compares the layout configuration of feeders 3 contained in each production program with the current feeder layout configuration indicated in the management information (step S 13).

Then, the control portion 18 calculates similarities of the production programs to the current feeder layout and displays the production programs in descending order of similarity on the display (step S14). For example, similarity is calculated based on whether or not the feeder layout contained in each production program coincides with the current feeder layout in terms of the region numbers of the feeder bank 19 and the kinds of electronic components 4. The similarity of the production program indicates a reduction rate of the operator's preparation work prior to operation. A production program most similar to the current feeder layout is selected by the operator (step S15). Then, the production program display process is terminated.

In this manner, in the embodiment, similarity between the current feeder layout and the layout configuration of the feeders 3 used in each of the production programs can be recognized by the operator. Thus, one of the production programs most similar to the current feeder layout can be selected by the operator to simplify the preparation work prior to operation, such as rearrangement of the feeders 3.

The invention is not limited to the embodiment but may be changed variously in a practical stage. The sizes, shapes, etc. illustrated in the accompanying drawings in the embodiment are not limited but may be changed suitably as long as the effect of the invention can be obtained. In addition, changes may be made suitably in a practical stage without departing from the scope of the invention.

For example, in the aforementioned embodiment, the correction quantities of the suction positions of the electronic components 4 and the use statuses of the feeders 3 have been described as intrinsic information of the feeders 3 by way of example. However, the invention is not limited to this configuration. Any information may be used as the intrinsic information of each feeder 3 as long as the information is feeder-specific information which can be taken over after the layout is changed. For example, the intrinsic information of the feeder 3 may include the kind of the electronic component 4. In addition, intrinsic information such as identification information of the tape reel 31 may be included in the intrinsic information of the feeder 3.

Although the aforementioned embodiment has shown the configuration in which each mounting apparatus 1 is connected to the server 2 by wire, the mounting apparatus 1 may be connected to the server 2 by wireless. Similarly, the mounting apparatus 1 may be connected to the feeder bank 19 by wireless. In addition, the feeder bank 19 may be connected to the server 2 through the mounting apparatus 1 or the mounting apparatus 1 may be connected to the server 2 through the feeder bank 19.

In addition, although the aforementioned embodiment has shown the configuration in which a plurality of feeders 3 are disposed side by side in the feeder bank 19, the invention is not limited to this configuration. The feeder bank 19 may be configured arbitrarily as long as a plurality of feeders 3 can be disposed in the feeder bank 19.

Although the aforementioned embodiment has shown the configuration in which the electronic components 4 are mounted on the board 5, the invention is not limited to this configuration. Configuration may be made so that electronic components 4 are mounted on another substrate than the board 5.

In addition, although the aforementioned embodiment has shown the configuration in which similarities of the production programs to the current feeder layout are displayed on the display, the invention is not limited to this configuration. Any configuration may be used as long as the operator can be informed of the similarities of the production programs to the current feeder layout. For example, configuration may be made so that the operator is informed of the similarities by sound or the like.

As described above, the invention has an effect that the preparation work prior to operation can be simplified. The invention is particularly useful for a production system in which layouts of feeders disposed in a plurality of mounting apparatuses are managed by a server.

What is claimed is:

1. A production system which is centralizedly managed by a server so that electronic components fed from component feeding devices are mounted on a substrate in a retention member of each mounting apparatus, wherein:
the component feeding devices are disposed in predetermined placement regions of a placement section in which a plurality of placement regions are formed in the mounting apparatus;
the server detects the placement regions where the component feeding devices are disposed, from the placement section, and manages the component feeding devices and the placement regions in association with each other; and
the mounting apparatus acquires management information from the server and automatically generates layout data indicating correspondence between the component feeding devices and the placement regions.

2. The production system according to claim 1, wherein:
the server manages intrinsic information of the component feeding devices in association with identification information of the component feeding devices; and
the mounting apparatus automatically generates the layout data including the intrinsic information of the component feeding devices.

3. The production system according to claim 2, wherein:
the server manages, as the intrinsic information of the component feeding devices, correction quantities for retention positions of the electronic components when the electronic components are delivered to the mounting apparatus from the component feeding devices, in association with the identification information of the component feeding devices; and
the mounting apparatus corrects the retention positions of the electronic components initially set based on the placement regions by the correction quantities, and automatically generates the layout data including the retention positions of the electronic components.

4. The production system according to claim 2, wherein:
the server manages, as the intrinsic information of the component feeding devices, information indicating use or non-use of the component feeding devices in association with the identification information of the component feeding devices; and
the mounting apparatus automatically generates the layout data including the information indicating use or non-use.

5. The production system according to claim 1, wherein:
the server detects the placement regions of the component feeding devices by proximity communication between the placement section and the component feeding devices.

6. The production system according to claim 1, wherein:
a plurality of production programs for mounting the electronic components on the substrate from the component feeding devices are stored in the mounting apparatus;
layout configurations of the component feeding devices used in the production programs respectively are set in the plurality of production programs; and
the mounting apparatus acquires the management information from the server and informs of similarities between a current layout configuration of the component feeding devices included in the management information and the layout configurations of the component feeding devices in the plurality of production programs.

7. A data generation method used in a production system which is centralizedly managed by a server so that electronic components fed from component feeding devices are mounted on a substrate in a retention member of each mounting apparatus, the method comprising:
a placement step of placing the component feeding devices in predetermined placement regions of a placement section in which a plurality of placement regions are formed in the mounting apparatus;
a management step of allowing the server to detect the placement regions where the component feeding devices are disposed, from the placement section, and to manage the component feeding devices and the placement regions in association with each other; and
a generation step of allowing the mounting apparatus to acquire management information from the server and to automatically generate layout data indicating correspondence between the component feeding devices and the placement regions.

8. The data generation method according to claim 7, wherein:
in the management step, the server manages intrinsic information of the component feeding devices in association with identification information of the component feeding devices; and
in the generation step, the mounting apparatus automatically generates the layout data including the intrinsic information of the component feeding devices.

9. The data generation method according to claim 8, wherein:
in the management step, the server manages, as the intrinsic information of the component feeding devices, correction quantities for retention positions of the electronic components when the electronic components are delivered to the mounting apparatus from the component feeding devices, in association with the identification information of the component feeding devices; and
in the generation step, the mounting apparatus corrects the retention positions of the electronic components initially set based on the placement regions by the correction quantities, and automatically generates the layout data including the retention positions of the electronic components.

10. The data generation method according to claim 8, wherein:
in the management step, the server manages, as the intrinsic information of the component feeding devices, information indicating use or non-use of the component feeding devices in association with the identification information of the component feeding devices; and
in the generation step, the mounting apparatus automatically generates the layout data including the information indicating use or non-use.

11. The data generation method according to claim 7, wherein:
in the management step, the server detects the placement regions of the component feeding devices by proximity communication between the placement section and the component feeding devices.

12. The data generation method according to claim 7, further comprising:
an informing step of allowing the mounting apparatus to acquire the management information from the server and to inform of similarities between a current layout configuration of the component feeding devices included in the management information and layout configurations of the component feeding devices in a plurality of production programs when the plurality of production programs for mounting the electronic components on the substrate from the component feeding devices are stored in the mounting apparatus and the layout configurations of the component feeding devices used in the production programs respectively are set in the plurality of production programs.
